(19) United States
(12) Patent Application Publication
(10) Pub. No.: US 2026/0358459 A1
(43) Pub. Date: Nov. 12, 2026

(54) SYSTEM FOR DETECTING ELECTROMAGNETIC SOURCE LOCATION

(71) Applicant: THE INDUSTRY & ACADEMIC COOPERATION IN CHUNGNAM NATIONAL UNIVERSITY (IAC), Daejeon (KR)

(72) Inventor: Jong Myung WOO, Daejeon (KR)

(73) Assignee: THE INDUSTRY & ACADEMIC COOPERATION IN CHUNGNAM NATIONAL UNIVERSITY (IAC), Daejeon (KR)

(21) Appl. No.: 19/072,303

(22) Filed: May 9, 2025

(51) Int. Cl. G01S 5/02

(52) U.S. Cl. CPC G01S 5/0268

(57) ABSTRACT

Proposed is a system for detecting location of an electromagnetic wave source configured to measure a time difference in which a wave scattered by an electromagnetic wave source is transmitted to an array antenna disposed on a specific axis in a time domain, the system being configured to detect an accurate location of the electromagnetic wave source by performing a simultaneous calculation of trigonometric equations. In the system, location information of a transmitting antenna or the electromagnetic wave source is calculated by using an intersection point where a distance rₓ, an angle ψₓ, a distance r_{y}, an angle ψ_{y}, a distance r_{z}, and an angle ψ_{z} that are calculated in a distance and angle calculation unit intersect each other.

### BACKGROUND

### Technical Field

The present disclosure relates to a system for detecting location of an electromagnetic wave source. More particularly, the present disclosure relates to a technology in which a location of an electromagnetic wave source or a generation location of a signal is accurately detected regardless of a distance between a receiving antenna and the electromagnetic wave source or the generation location of the signal.

### Description of the Related Art

Technologies for detecting a generation location of an electromagnetic wave source, a sound source, an ultrasonic wave source, or a light source signal are required. For example, recently, various electronic devices or components are mounted in a vehicle, and the more such electronic devices are mounted, the higher the possibility that an electromagnetic interference problem may occur.

In other words, due to spurious waves generated in the electronic devices, the components for generating electricity for the vehicle, and so on, the vehicle may malfunction due to electromagnetic interference, and this situation may cause a big accident of the vehicle, which may lead to a loss of life.

Therefore, recently, an Electro Magnetic Compatibility (EMC) countermeasure for a vehicle by measuring spurious waves generated in the vehicle by using a broadband antenna so as to prevent an accident has become important.

In addition, a recent aircraft is provided with an expensive weapon and an advanced electronic device, and it is a very important factor to determine a victory or a defeat by penetrating deep into a rear side of an opponent and attacking a target while minimizing the loss of the friendly aircraft.

Therefore, a technology of tracking locations of aircrafts by firing electromagnetic waves (wavelength of 1 cm to 10 cm) that have a strong straightness from an interception radar to the aircrafts and then analyzing reflected waves or scattered waves that return to the interception radar is developed.

However, in a conventional measurement device for a generation location of spurious waves or a signal, a direction of the generation location of the signal is tracked by measuring a phase difference between a transmitting antenna and a receiving antenna, so that there is a problem that an error increases as a measurement distance decreases.

### DOCUMENT OF RELATED ART

(Patent Document 1) Korean Patent Application Publication No. 10-2009-0052411 (published on May 26, 2009)
(Patent Document 2) Korean Patent No. 10-2202072 (published on Jan. 12, 2021)

### SUMMARY

Accordingly, the present disclosure has been made keeping in mind the above problems occurring in the related art, and an objective of the present disclosure is to provide a system for detecting location of an electromagnetic wave source solving a disadvantage in the related art and capable of accurately detecting a location of an electromagnetic wave source regardless of a distance between a receiving antenna and a location or a transmitting antenna or a generation location of an electromagnetic wave such as an electromagnetic wave source.

In addition, in order to achieve the objective of the present disclosure, according to an aspect of the present disclosure, there is provided a system for detecting location of an electromagnetic wave source including a server device and a receiving array antenna configured to detect a signal transmitted from a transmitting antenna or an electromagnetic wave source.

In addition, the server device may include a location setting unit, a distance and angle calculation unit, and a location information calculation unit.

The location setting unit may set a location of the receiving array antenna disposed on two axes of predetermined three-dimensional coordinate axes.

That is, when a location of an arbitrary electromagnetic wave source or an arbitrary transmitting antenna is assumed as P(x,y,z) on the three-dimensional coordinate axes, the location setting unit may set coordinates of x-axis receiving array antennas as #O(0,0,0), #x₊(x′,0,0), and #x₋(x″,0,0), coordinates of y-axis receiving array antennas as #O(0,0,0), #y₊(0,0,y′), and #y₋(0,0,y″), and coordinates of z-axis receiving array antennas as #O(0,0,0), #z₊(0,0,z′), and #z₋(0,0,z″).

In addition, the distance and angle calculation unit may measure a time of arrival from the transmitting antenna or the electromagnetic wave source to the receiving array antenna in the time domain, and may calculate a distance difference in a path reaching each antenna of the receiving array antenna from the transmitting antenna or the electromagnetic wave source by using the time of arrival.

In addition, the distance and angle calculation unit may calculate a distance from an origin point on the three-dimensional coordinate axes to the transmitting antenna or the electromagnetic wave source and an angle between the transmitting antenna or the electromagnetic wave source and the coordinate axis on the basis of the calculated distance difference. In addition, the location information calculation unit may calculate location information of the transmitting antenna or the electromagnetic wave source by using the distance and the angle that are calculated in the distance and angle calculation unit.

At this time, the location information calculation unit may calculate the location information of the transmitting antenna or the electromagnetic wave source by using an intersection point where a distance Rₓ from the origin point to the transmitting antenna or the electromagnetic wave source and an angle ψₓ between an extension line from the origin point to the receiving array antenna on the x-axis and an extension line from the origin point to the transmitting antenna or the electromagnetic wave source calculated in the distance and angle calculation unit on the basis of the receiving array antenna on the x-axis and a distance R_{y} from the origin point to the transmitting antenna or the electromagnetic wave source and an angle ψ_{y} between an extension line from the origin point to the receiving array antenna on the y-axis and an extension line from the origin point to the transmitting antenna or the electromagnetic wave source calculated in the distance and angle calculation unit on the basis of the receiving array antenna on the y-axis intersect each other.

At this time, the location information calculation unit may calculate the location information of the transmitting antenna or the electromagnetic wave source by using an intersection point where the distance Rₓ from the origin point to the transmitting antenna or the electromagnetic wave source and the angle ψₓ between the extension line from the origin point to the receiving array antenna on the x-axis and the extension line from the origin point to the transmitting antenna or the electromagnetic wave source calculated in the distance and angle calculation unit on the basis of the receiving array antenna on the x-axis and a distance R_{z} from the origin point to the transmitting antenna or the electromagnetic wave source and an angle ψ_{z} between an extension line from the origin point to the receiving array antenna on the z-axis and an extension line from the origin point to the transmitting antenna or the electromagnetic wave source calculated in the distance and angle calculation unit on the basis of the receiving array antenna on the z-axis intersect each other.

At this time, the location information calculation unit may calculate the location information of the transmitting antenna or the electromagnetic wave source by using an intersection point where the distance R_{z} from the origin point to the transmitting antenna or the electromagnetic wave source and the angle ψ_{z} between the extension line from the origin point to the receiving array antenna on the z-axis and the extension line from the origin point to the transmitting antenna or the electromagnetic wave source calculated in the distance and angle calculation unit on the basis of the receiving array antenna on the z-axis and the distance R_{y} from the origin point to the transmitting antenna or the electromagnetic wave source and the angle ψ_{y} between the extension line from the origin point to the receiving array antenna on the y-axis and the extension line from the origin point to the transmitting antenna or the electromagnetic wave source calculated in the distance and angle calculation unit on the basis of the receiving array antenna on the y-axis intersect each other.

As described above, the system for detecting location of an electromagnetic wave source according to the present disclosure has an effect that a generation location of the electromagnetic wave source is capable of being accurately detected regardless of a distance between the receiving antenna and the generation location of the electromagnetic wave source including a scattering body or a signal.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a configuration diagram illustrating a system for detecting location of an electromagnetic wave source according to an embodiment of the present disclosure;

FIG. 2 is a block diagram illustrating the system for detecting location of an electromagnetic wave source according to an embodiment of the present disclosure;

FIG. 3 is a view illustrating a location of an x-axis receiving array antenna for measuring a location of a transmitting antenna according to an embodiment of the present disclosure;

FIG. 4 is a view illustrating a location of a y-axis receiving array antenna for measuring a location of the transmitting antenna according to an embodiment of the present disclosure;

FIG. 5 is a view illustrating a location of a z-axis receiving array antenna for measuring a location of the transmitting antenna according to an embodiment of the present disclosure; and

FIG. 6 is a view illustrating an actual implementation of the system for detecting location of an electromagnetic wave source according to an embodiment of the present disclosure.

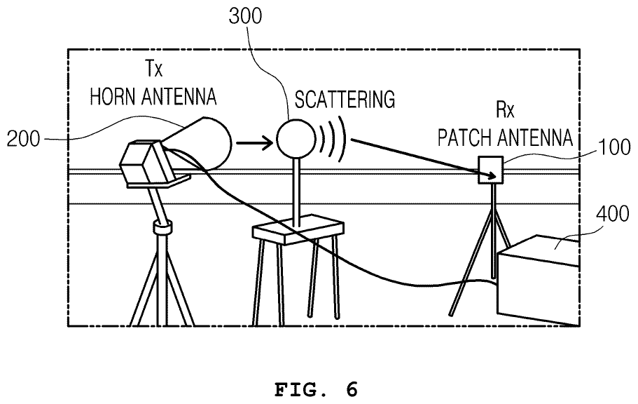

### DETAILED DESCRIPTION

Hereinafter, an embodiment of the present disclosure will be described in detail with reference to the accompanying drawings such that a person having ordinary knowledge in the technical field to which the present disclosure belongs may easily implement the embodiment. However, the present disclosure is not limited to the embodiment described herein, and may be embodied in many different forms. In addition, in order to clearly describe the present disclosure with reference to the drawings, parts irrelevant to the description are omitted, and similar reference numerals denote similar parts throughout the specification.

Throughout the present specification, when a part is referred to as “including” an element, it means that the part may include other elements as well without excluding the other elements unless specifically stated otherwise. In addition, the terms “ . . . part”, “ . . . unit”, “ . . . module”, and the like described herein may mean a unit for processing at least one function or operation, and they may be implemented in hardware, software, or a combination of hardware and software.

Hereinafter, the present disclosure will be described in detail by describing an exemplary embodiment of the present disclosure with reference to the accompanying drawings.

The same reference numerals shown in each drawing indicate the same members.

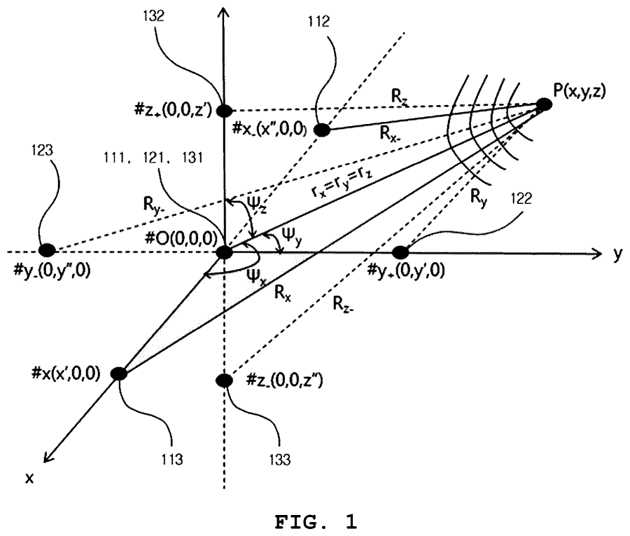

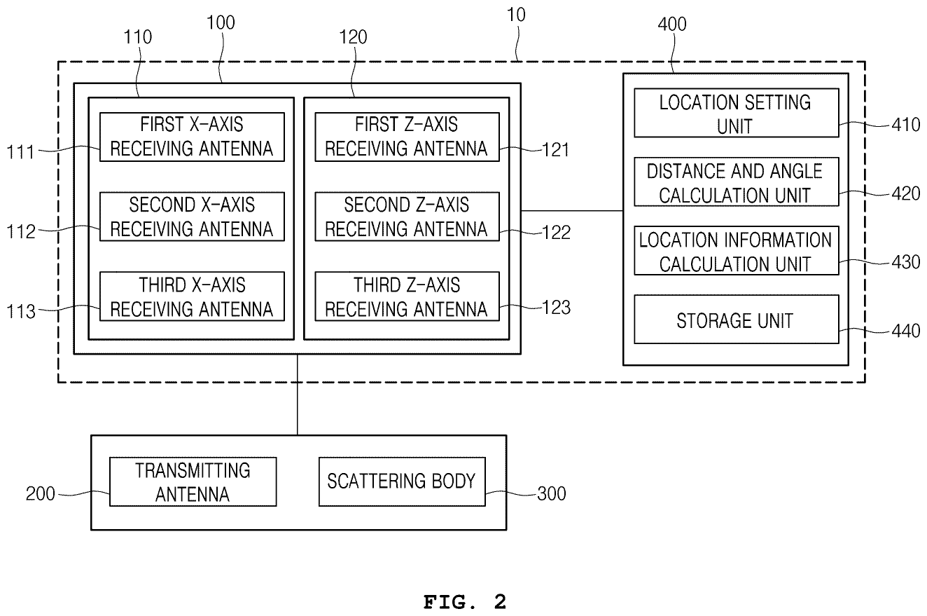

FIG. 1 is a configuration diagram illustrating a system for detecting location of an electromagnetic wave source according to an embodiment of the present disclosure, and FIG. 2 is a block diagram illustrating the system for detecting location of an electromagnetic wave source according to an embodiment of the present disclosure.

A system for detecting location of an electromagnetic wave source 10 according to an embodiment of the present disclosure may include a receiving array antenna 100 and a server device 400. The receiving array antenna 100 may detect a signal transmitted from a transmitting antenna 200 or from an electromagnetic wave source 300.

In addition, referring to FIG. 1, the receiving array antenna 100 is arranged on two axes of predetermined three-dimensional coordinate axes. That is, the receiving array antenna 100 may be arranged on any two axes selected from an x-axis, a y-axis, and a z-axis of the three-dimensional coordinate axes. According to an embodiment of the present disclosure, the receiving array antenna 100 is arranged on the three axes of the x-axis, the y-axis, and the z-axis.

At this time, the transmitting antenna 200 and the electromagnetic wave source 300 may be selectively used as a generation location of a signal. That is, when a signal is directly transmitted from the transmitting antenna 200 to the receiving array antenna 100, the transmitting antenna 200 is applied as the generation source of the signal. When a signal transmitted from the transmitting antenna 200 is scattered through the electromagnetic wave source 300 and is transmitted to the receiving array antenna 100, the electromagnetic wave source 300 may be applied as the generation source of the signal.

In addition, the server device 400 may include a location setting unit 410, a distance and angle calculation unit 420, a location information calculation unit 430, and a storage unit 440. The location setting unit 410 is capable of setting a location of the receiving array antenna 100 on the three-dimensional coordinate axes. According to an embodiment of the present disclosure, the receiving array antenna 100 may include an x-axis receiving array antenna 110 located on the x-axis of the three-dimensional coordinate axes, a y-axis receiving array antenna 120 located on the y-axis of the three-dimensional coordinate axes, and a z-axis receiving array antenna 130 located on the z-axis of the three-dimensional coordinate axes.

In addition, the distance and angle calculation unit 420 is capable of calculating a distance and an angle from the receiving array antenna 100 to the electromagnetic wave source 300 or the transmitting antenna 200 by using the receiving array antenna 100 arranged through the location setting unit 410.

That is, the distance and angle calculation unit 420 measures a time of arrival from the transmitting antenna 200 or the electromagnetic wave source 300 to the receiving array antenna 100 in a time domain. In addition, the distance and angle calculation unit 420 calculates path distance differences from the transmitting antenna 200 or the electromagnetic wave source 300 to each antenna of the receiving array antenna 100 by using the time of arrival, and calculates the distance and the angle from an origin point (0,0,0) of the three-dimensional coordinate axes to the transmitting antenna 200 or the electromagnetic wave source 300 on the basis of the distance differences.

As illustrated in FIG. 1, when a location of an arbitrary electromagnetic wave source 300 or an arbitrary transmitting antenna 200 on the three-dimensional coordinate axes is assumed to be P(x,y,z), the locating setting unit 410 may set a location of the x-axis receiving array antenna 110 such that a coordinate of a first x-axis receiving antenna 111 is set as #O(0,0,0), a coordinate of a second x-axis receiving antenna 112 is set as #x(x′,0,0), and a coordinate of a third x-axis receiving antenna 113 is set as #x₋(x″,0,0). Furthermore, the 2D location setting unit 410 may set a location of the y-axis receiving array antenna 120 such that a coordinate of a first y-axis receiving antenna 121 is set as #O(0,0,0), a coordinate of a second y-axis receiving antenna 122 is set as #y₊(0,y′, 0), and a coordinate of a third y-axis receiving antenna 123 is set as #y₋(0,y″,0). In addition, a location of the receiving array antenna on the z-axis may be set such that a coordinate of a first z-axis receiving antenna is set as #O(0,0,0), a coordinate of a second z-axis receiving antenna is set as #z₊(0,0,z′), and a coordinate of a third z-axis receiving antenna is set as #z₋(0,0,z″).

At this time, the distance and angle calculation unit 420 measures a distance difference in a path that reaches the receiving antenna 100 from the location point P(x,y,z) of the transmitting antenna 200 in the time domain.

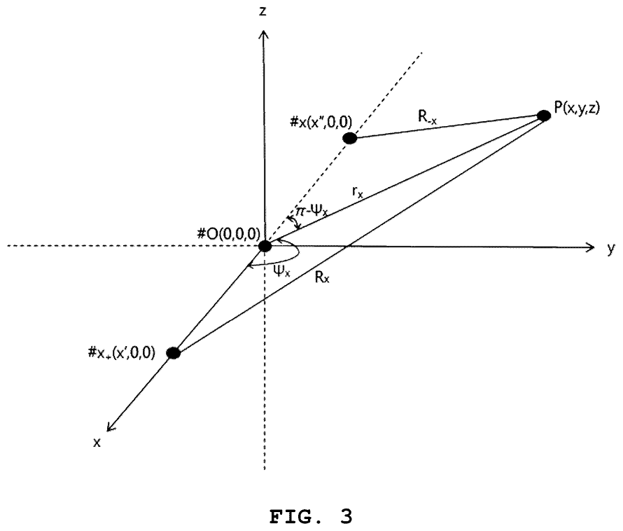

Referring to FIG. 3 to FIG. 5, the x-axis arrangement, the y-axis arrangement, and the z-axis arrangement on the three-dimensional coordinate axes are described below.

FIG. 3 is a view illustrating a location of the x-axis receiving array antenna 110 for measuring a location of the transmitting antenna 200 according to an embodiment of the present disclosure. That is, FIG. 3 is a view illustrating measuring of a location of a transmitting antenna 221 on a parallel line of the x-axis by using the x-axis receiving array antenna 110 arranged according to an embodiment of the present disclosure.

As illustrated in FIG. 3, the location setting unit 410 may arrange the receiving array antenna 100 on the x-axis of the three-dimensional coordinate axes. According to an embodiment of the present disclosure, a monopole array antenna having a “L” shape may be disposed.

In addition, the distance and angle calculation unit 420 may calculate an angle ψₓ between a linear path axis from the origin point on the three-dimensional coordinate axes to the receiving array antenna 100 and a linear path axis from the origin point to the transmitting antenna 200.

At this time, the distance and angle calculation unit 420 may generate a function related to an angle between a reference axis formed of an extension line from the origin point on the three-dimensional coordinate axes to the receiving array antenna 100 and a linear path between the transmitting antenna 200 and the receiving array antenna 100, and may calculate the angle Tx.

First, in order to calculate the distance between the receiving array antenna 100 and the transmitting antenna 200, a calculation is performed as shown in [Equation 1] below.

Rₓ=\sqrt{(x−x′)²+(y−y′)²+(z−z′)²} [Equation 1]

Here, the Rₓ represents a spatial distance between an arbitrary point (x′,y′,z′) on the x-axis and a point P(x,y,z) of the transmitting antenna 200.

At this time, a spatial distance rₓ between the coordinate #O(0,0,0) of the first x-axis receiving antenna 111 and the point P(x,y,z) of the transmitting antenna 200 may be represented by a trigonometric equation as shown in [Equation 2] below.

rₓ=\sqrt{x²+y²+z²} [Equation 2]

In addition, a spatial distance Rₓ between the coordinate #x₊(x′,0,0) of the second x-axis receiving antenna 112 and the point P(x,y,z) of the transmitting antenna 200 may be represented by a trigonometric equation as shown in [Equation 3]below.

$$\begin{matrix}{R}_{x} = \sqrt{{( x - {x}^{′} )}^{2} + {y}^{2} + {z}^{2}} \\ = \sqrt{{x}^{2} - 2 {xx}^{′} + {x}^{′2} + {y}^{2} + {z}^{2}} , ( {r}_{x} = {x}^{2} + {y}^{2} + {z}^{2} ) \\ = \sqrt{{r}_{x}^{2} - 2 {x}^{′} cos {ψ}_{x} + {x}^{′}} , ( x = {r}_{x} cos {ψ}_{x} )\end{matrix} \qquad [ Equation 3 ]$$

Here, ψₓ represents an angle formed between the x-axis and the distance Rₓ from the coordinate P(x,y,z) of the first x-axis receiving antenna 111 to the transmitting antenna 200.

In addition, when [Equation 3] is summarized, [Equation 3] may be expressed as [Equation 4] below.

$${R}_{x}^{2} = {r}_{x}^{2} - 2 {x}^{′} {r}_{x} cos {ψ}_{x} + {x}^{′ 2} \qquad [ Equation 4 ]$$

$${r}_{x}^{2} - {R}_{x}^{2} = 2 {x}^{′} {r}_{x} cos {ψ}_{x} - {x}^{′ 2}$$

$$( {r}_{x} - {R}_{x} ) ( {r}_{x} + {R}_{x} ) = 2 {x}^{′} {r}_{x} cos {ψ}_{x} - {x}^{′ 2}$$

At this time, as illustrated in FIG. 3, rₓ−Rₓ is a receiving time difference value that can be known by measuring the time of arrival from the coordinate P(x,y,z) of the transmitting antenna 200 to the receiving antennas 100 #O(0,0,0) and #x₊(x′,0,0) in the time domain. When rₓ−Rₓ is assumed as A and rearranged, [Equation 5] below may be represented.

f(rₓ,ψₓ)=A(rₓ+(rₓ−A))=2x′rₓ cos ψᵣ_{ₓ}−x′² [Equation 5]

Similarly, when a spatial distance between the coordinate #x₋(x″,0,0) of the third x-axis receiving antenna 113 and the location of the transmitting antenna 200 is defined as R₋ₓ and rₓ−R₋ₓ is assumed as a measurement value B and is rearranged, [Equation 6] below may be represented.

Here, π-ψₓ represents an angle ψₓ formed between the x-axis and the distance rₓ₋ from the coordinate #x₋(x″,0,0) of the first x-axis receiving antenna 111 to the location of the transmitting antenna 200.

f(rₓ,ψₓ)=B(rₓ+(rₓ−B))=2x″rₓ cos′(π−ψₓ)−(x″)² [Equation 6]

At this time, Rₓ″ equals to 1λ to 5λ, and values of x′ and x″ may be values that can be preset and changed at an array interval of the antenna. By using this, the distance and angle calculation unit 420 may calculate the Rₓ value and the ψₓ value by simultaneous equations of [Equation 5] and [Equation 6].

[Table 1] below shows a calculation example of a distance Rₓ and an angle ψₓ between the x-axis receiving array antenna 110 and the transmitting antenna 211 on a first x-axis parallel line.

TABLE 1
location of the transmitting antenna 211 on the first x-axis parallel line

| rₓ[mm][1λ: 122.45 mm] | | | ψₓ [°] | | |
|---|---|---|---|---|---|
| CALCULATION | MEASUREMENT | ERROR(%) | CALCULATION | MEASUREMENT | ERROR(%) |
| 122.45 | 122.45 | 0(0) | 90 | 72.7 | 17.3(19.2) |
| 244.9 | 253.61 | 8.71(3.6) | 90 | 88.9 | 1.1(1.2) |
| 367.35 | 366 | 1.35(0.4) | 90 | 86.7 | 3.3(3.6) |
| 489.8 | 497.19 | 7.39(1.5) | 90 | 84.4 | 5.6(6.2) |
| 612.25 | 609.61 | 2.64(0.4) | 90 | 87.3 | 2.7(3) |

In addition, [Table 2] below shows a calculation example of a distance Rₓ and an angle ψₓ between the x-axis receiving array antenna 110 and a transmitting antenna 212 on a second x-axis parallel line.

TABLE 2
location of the transmitting antenna 212 on the second x-axis parallel line

| rₓ[mm][1λ: 122.45 mm] | | | ψₓ [°] | | |
|---|---|---|---|---|---|
| CALCULATION | MEASUREMENT | ERROR(%) | CALCULATION | MEASUREMENT | ERROR(%) |
| 324.03 | 309.82 | 14.21(4.4) | 22.2 | 23.1 | 0.9(4.1) |
| 387.27 | 366.03 | 21.24(5.5) | 39.2 | 49.1 | 0.5(1.3) |
| 474.28 | 478.46 | 14.57(3.1) | 50.8 | 48.9 | 1.9(3.7) |
| 574.37 | 572.14 | 2.23(0.4) | 58.5 | 58.4 | 0.1(0.2) |
| 681.8 | 684.56 | 15.98(2.3) | 63.9 | 63.2 | 0.7(1.1) |

In addition, [Table 3] below shows a distance Rₓ and an angle ψₓ between the x-axis receiving array antenna 110 and a third x-axis transmitting antenna 213.

TABLE 3
location of the transmitting antenna 213 on the third x-axis parallel line

| rₓ[mm][1λ: 122.45 mm] | | | ψₓ [°] | | |
|---|---|---|---|---|---|
| CALCULATION | MEASUREMENT | ERROR(%) | CALCULATION | MEASUREMENT | ERROR(%) |
| 612.37 | 647.09 | 32.72(5.7) | 11.5 | 11.8 | 0.2(1.7) |
| 648.06 | 647.09 | 0.97(0.1) | 22.2 | 24.9 | 2.7(12.2) |
| 703.52 | 684.56 | 18.96(2.7) | 31.5 | 33.2 | 1.7(5.4) |
| 774.53 | 740.77 | 33.76(4.4) | 39.2 | 42.6 | 3.4(8.7) |
| 857.23 | 834.71 | 22.52(2.6) | 45.6 | 46.9 | 1.3(2.9) |

That is, [Table 1], [Table 2], and [Table 3] show a set value of the distance Rₓ and the angle ψₓ according to the location of the transmitting antenna on the x-axis parallel line calculated by using the system for detecting location of an electromagnetic wave source according to an embodiment of the present disclosure, and show an actual measurement result and an error.

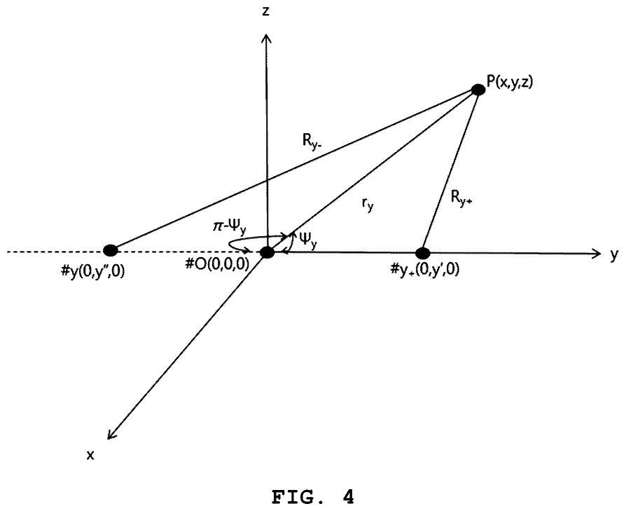

FIG. 4 is a view illustrating a location of the y-axis receiving array antenna 120 for measuring a location of the transmitting antenna 200 according to an embodiment of the present disclosure. That is, FIG. 4 is a view illustrating measuring of a location of the transmitting antenna 221 on a parallel line of the y-axis by using the y-axis receiving array antenna 120 arranged according to an embodiment of the present disclosure.

As illustrated in FIG. 4, the location setting unit 410 may arrange the receiving array antenna 100 on the y-axis of the three-dimensional coordinate axes. According to an embodiment of the present disclosure, a monopole array antenna having a “L” shape may be disposed.

In addition, the distance and angle calculation unit 420 may calculate an angle ψ_{y} between a linear distance axis from the origin point on the three-dimensional coordinate axes to the receiving array antenna 100 and a linear distance axis from the origin point to the transmitting antenna 200. That is, a calculation method same as the calculation method of the distance Rₓ and the angle ψₓ for the x-axis receiving array antenna 110 may be applied.

At this time, the distance and angle calculation unit 420 may generate a function related to an angle between a reference axis formed of an extension line from the origin point on the three-dimensional coordinate axes to the receiving array antenna 100 and a linear path between the transmitting antenna 200 and the receiving array antenna 100, and may calculate the angle ψ_{y}.

That is, the distance and angle calculation unit 420 may calculate the distance and the angle from the origin point (0,0,0) on the three-dimensional coordinate axes to the transmitting antenna 200 or the electromagnetic wave source 300 by using the receiving array antenna 100 arranged on the y-axis on the three-dimensional coordinate axes. At this time, the location setting unit 410 may set coordinates of the y-axis receiving array antenna 120 to #O(0,0,0), #y₊(0, y′, 0), and #y₋(0, y″,0).

That is, r_{y}−R_{y} is a receiving time difference value that can be known by measuring a distance difference in a path reaching the receiving array antenna 100 from the coordinate P(x,y,z) of the transmitting antenna 200 in the time domain. When r_{y}−R_{y} is assumed as C and rearranged, [Equation 7]below may be represented.

f(r_{y},ψ_{y})=C(r_{y}+(r_{y}−C))=2y′r_{y} cos ψ_{y}−y′² [Equation 7]

Here, r_{y} represents a distance from the origin point to the transmitting antenna 200 or the electromagnetic wave source 300, and R_{y} represents a distance from the coordinate #y₊(0,y′,0) of the receiving array antenna 100 on the y-axis to the transmitting antenna 200 or the electromagnetic wave source 300. In addition, ψ_{y} represents an angle between a linear path axis from the origin point on the three-dimensional coordinate axes to the receiving array antenna 100 on the y-axis and a linear path axis from the origin point to the transmitting antenna 200.

In addition, when a spatial distance from a coordinate #y₋(0,y″,0) of the receiving array antenna 100 on the y-axis to the transmitting antenna 200 or the electromagnetic wave source 300 is represented as R_{y-} and r_{y}−R_{y-} is assumed as a measurement value D and rearranged, [Equation 8] below may be represented.

f(r_{y},ψ_{y})=D(r_{y}+(r_{y}−D))=2y″r_{y} cos(π−ψ_{y})−(y″)² [Equation 8]

In addition, the location information calculation unit 430 calculates location information of the transmitting antenna 200 or the electromagnetic wave source 300 by using the distance value and the angle value calculated from the distance and angle calculation unit 2D 420.

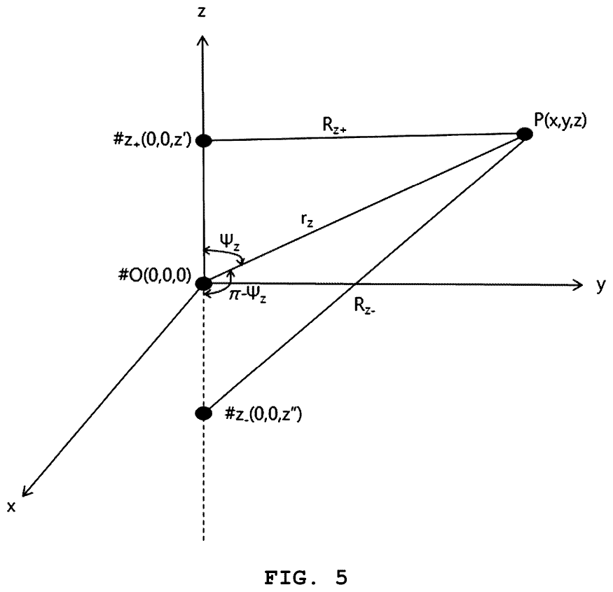

FIG. 5 is a view illustrating a location of the z-axis receiving array antenna 130 for measuring a location of the transmitting antenna 200 according to an embodiment of the present disclosure. That is, FIG. 5 is a view illustrating measuring of a location of the transmitting antenna 221 on the z-axis parallel line by using the z-axis receiving array antenna 130 arranged according to an embodiment of the present disclosure.

As illustrated in FIG. 5, the location setting unit 410 may arrange the receiving array antenna 100 on the z-axis on the three-dimensional coordinate axes. According to an embodiment of the present disclosure, a monopole array antenna having a “L” shape may be disposed.

In addition, the distance and angle calculation unit 420 may calculate an angle ψ_{z} between a linear distance axis from the origin point on the three-dimensional coordinate axes to the receiving array antenna 100 and a linear distance axis from the origin point to the transmitting antenna 200. That is, a calculation method same as the calculation method of the distance Rₓ and the angle ψₓ for the x-axis receiving array antenna 110 may be applied.

At this time, the distance and angle calculation unit 420 may generate a function related to an angle between a reference axis formed of an extension line from the origin point on the three-dimensional coordinate axes to the receiving array antenna 100 and a linear path between the transmitting antenna 200 and the receiving array antenna 100, and may calculate the angle ψ_{z}.

That is, the distance and angle calculation unit 420 may calculate the distance and the angle from the origin point (0,0,0) on the three-dimensional coordinate axes to the transmitting antenna 200 or the electromagnetic wave source 300 by using the receiving array antenna 100 arranged on the z-axis on the three-dimensional coordinate axes. At this time, the location setting unit 410 may set coordinates of the z-axis receiving array antenna 130 to #O(0,0,0), #z₊(0,0,z′), and #z₋(0, 0, z″)

That is, r_{z}−R_{z+} is a receiving time difference value that can be known by measuring a distance difference in a path reaching the receiving array antenna 100 from the coordinate P(x,y,z) of the transmitting antenna 200 in the time domain. When r_{z}−R_{z+} is assumed as E and rearranged, [Equation 9]below may be represented.

f(r_{z},ψ_{z})=E(r_{z}+(r_{z}−E))=2z′r_{z} cos ψ_{z}−z′² [Equation 9]

Here, r_{z} represents a distance from the origin point to the transmitting antenna 200 or the electromagnetic wave source 300, and R_{z+} represents a distance from the coordinate #z₊(0,0,z′) of the receiving array antenna 100 on the z-axis to the transmitting antenna 200 or the electromagnetic wave source 300. In addition, ψ_{z} represents an angle between a linear path axis from the origin point on the three-dimensional coordinate axes to the receiving array antenna 100 on the z-axis and a linear path axis from the origin point to the transmitting antenna 200.

In addition, when a spatial distance from the coordinate #z₋(0,0,z″) of the receiving array antenna 100 on the z-axis to the transmitting antenna 200 or the electromagnetic wave source 300 is represented as R_{z-} and r_{z}−R_{z-} is assumed as a measurement value E and rearranged, [Equation 10]below may be represented.

f(r_{z},ψ_{z})=F(r_{z}+(r_{z}−F))=2z″r_{z} cos(π−ψ_{z})−(z″)² [Equation 10]

In addition, the location information calculation unit 430 calculates location information of the transmitting antenna 200 or the electromagnetic wave source 300 by using the distance value and the angle value calculated from the distance and angle calculation unit 420.

[Table 4] below shows a set distance r_{z} and an angle ψᵣ_{_{z}} between the z-axis receiving array antenna 130 and the transmitting antenna 221 on a first z-axis parallel line.

TABLE 4
location of the transmitting antenna 221 on the first z-axis parallel line

| r_{z}[mm][1λ: 122.45 mm] | | | ψᵣ_{_{z}}[°] | | |
|---|---|---|---|---|---|
| CALCULATION | MEASUREMENT | ERROR(%) | CALCULATION | MEASUREMENT | ERROR(%) |
| 122.45 | 122.45 | 0(0) | 90 | 72.7 | 17.3(19.2) |
| 244.9 | 234.88 | 10.02(4.1) | 90 | 79.1 | 10.9(12.1) |
| 367.35 | 366.03 | 1.32(0.4) | 90 | 82.8 | 7.2(8) |
| 489.8 | 478.46 | 11.44(2.3) | 90 | 82.4 | 7.6(8.4) |
| 612.25 | 590.88 | 21.37(3.5) | 90 | 85.8 | 4.2(4.6) |

In addition, [Table 5]below shows a calculation of a distance r_{z} and an angle ψᵣ_{_{z}} between the z-axis receiving array antenna 130 and a transmitting antenna 222 on a second z-axis parallel line.

TABLE 5
location of the transmitting antenna 222 on the second z-axis parallel line

| r_{z}[mm][1λ: 122.45 mm] | | | ψᵣ_{_{z}}[°] | | |
|---|---|---|---|---|---|
| CALCULATION | MEASUREMENT | ERROR(%) | CALCULATION | MEASUREMENT | ERROR(%) |
| 324.03 | 347.3 | 23.27(7.2) | 22.2 | 20.2 | 2(0.1) |
| 387.27 | 422.25 | 34.98(9) | 39.2 | 32.7 | 6.5(16.6) |
| 474.28 | 497.19 | 22.91(4.8) | 50.8 | 47.1 | 3.4(7.3) |
| 574.37 | 590.88 | 16.51(2.9) | 58.5 | 53.6 | 4.9(8.4) |
| 681.8 | 665.83 | 2.76(0.4) | 63.9 | 62.5 | 1.4(2.2) |

In addition, [Table 6]below shows a calculation of a distance r_{z} and an angle ψᵣ_{_{z}} between the z-axis receiving array antenna 130 and a transmitting antenna 223 on a third z-axis parallel line.

TABLE 6
location of the transmitting antenna 223 on the third z-axis parallel line

| r_{z}[mm][1λ: 122.45 mm] | | | ψᵣ_{_{z}}[°] | | |
|---|---|---|---|---|---|
| CALCULATION | MEASUREMENT | ERROR(%) | CALCULATION | MEASUREMENT | ERROR(%) |
| 612.37 | 647.09 | 4.72(0.8) | 11.5 | 10.4 | 1.1(9.6) |
| 648.06 | 684.56 | 36.5(5.6) | 22.2 | 19.7 | 2.5(11.3) |
| 703.52 | 740.78 | 37.26(5.3) | 31.5 | 29.4 | 2.1(6.7) |
| 774.53 | 815.45 | 40.92(5.3) | 39.2 | 35.6 | 3.6(9.2) |
| 857.23 | 872.45 | 15.22(1.8) | 45.6 | 42.5 | 3.1(6.8) |

That is, [Table 4], [Table 5], and [Table 6] show a set value of the distance r_{z} and the angle ψ_{z} according to the location of the transmitting antenna on the z-axis parallel line calculated by using the system for detecting location of an electromagnetic wave source according to an embodiment of the present disclosure, and show an actual measurement result and an error.

At this time, the location information calculation unit 430 may calculate location information of the transmitting antenna 200 or the electromagnetic wave source 300 by using an intersection point where the distance rₓ and the angle ψₓ from the origin point to the transmitting antenna 200 or the electromagnetic wave source 300 calculated by using [Equation 5] and [Equation 6] and the distance r_{y} and the angle ψ_{y} from the origin point to the transmitting antenna 200 or the electromagnetic wave source 300 calculated by using [Equation 7] and [Equation 8] intersect each other.

In addition, the location information calculation unit 430 may calculate location information of the transmitting antenna 200 or the electromagnetic wave source 300 by using an intersection point where the distance rₓ and the angle ψₓ from the origin point to the transmitting antenna 200 or the electromagnetic wave source 300 calculated by using [Equation 5] and [Equation 6] and the distance r_{z} and the angle ψ_{z} from the origin point to the transmitting antenna 200 or the electromagnetic wave source 300 calculated by using [Equation 9] and [Equation 10] intersect each other.

In addition, the location information calculation unit 430 may calculate location information of the transmitting antenna 200 or the electromagnetic wave source 300 by using an intersection point where the distance r_{z} and the angle ψ_{z} from the origin point to the transmitting antenna 200 or the electromagnetic wave source 300 calculated by using [Equation 9] and [Equation 10] and the distance r_{y} and the angle ψ_{y} from the origin point to the transmitting antenna 200 or the electromagnetic wave source 300 calculated by using [Equation 7] and [Equation 8] intersect each other.

In addition, the storage unit 440 may store location information of the receiving array antenna 100 set through the location setting unit 410, and may store information on a distance and an angle from the receiving array antenna 100 to the electromagnetic wave source 300 or the transmitting antenna 200 calculated from the distance and angle calculation unit 420. In addition, the storage unit 400 stores a simultaneous equation function for calculating distance and angle information in the distance and angle calculation unit 420.

As described above, the distance rₓ and the angle ψₓ of the transmitting antenna 200 may be calculated by using the x-axis receiving array antenna 110 as illustrated in FIG. 3, and the distance r_{y} and the angle ψ_{y} of the transmitting antenna 200 may be calculated by using the y-axis receiving array antenna 120 as illustrated in FIG. 4.

That is, as illustrated in FIG. 3, when a difference in a time of arrival of an incident wave from the transmitting antenna 200 in an arbitrary location or a scattered wave from the electromagnetic wave source 300 in an arbitrary location is measured in the time domain by using the coordinates #O(0,0,0), #x+(x′,0,0), and #x−(x″,0,0) of the x-axis receiving array antennas 110 on the three-dimensional coordinate axes, the distance rₓ and the angle ψₓ from the x-axis to the transmitting antenna 200 may be calculated.

In addition, as illustrated in FIG. 4, when a difference in a time of arrival of an incident wave from the transmitting antenna 200 in an arbitrary location or a scattered wave from the electromagnetic wave source 300 in an arbitrary location is measured in the time domain by using the coordinates #O(0,0,0), #y+(0,y′,0), and #y−(0,y″,0) of the y-axis receiving array antennas 120 on the three-dimensional coordinate axes, the distance r_{y} and the angle ψ_{y} from the y-axis to the transmitting antenna 200 may be calculated.

That is, as illustrated in FIG. 5, when a difference in a time of arrival of an incident wave from the transmitting antenna 200 in an arbitrary location or a scattered wave from the electromagnetic wave source 300 in an arbitrary location is measured in the time domain by using the coordinates #O(0,0,0), #z₊(0,0,z′), and #z₋(0,0,z″) of the z-axis receiving array antennas 130 on the three-dimensional coordinate axes, the distance r_{z} and the angle ψ_{z} from the z-axis to the transmitting antenna 200 may be calculated.

In addition, a spatial location of the transmitting antenna 200 or the electromagnetic wave source 300 may be acquired by acquiring an intersection point where the distance rₓ and the angle ψₓ of the transmitting antenna 200 with respect to the x-axis, the distance r_{y} and the angle ψ_{y} of the transmitting antenna 200 with respect to the y-axis, and the distance r_{z} and the angle ψ_{z} of the transmitting antenna 200 with respect to the z-axis intersect each other.

Although exemplary embodiments of the present disclosure have been described, the present disclosure is not limited to the embodiments, and includes all the modifications within a range easily modified from the embodiments of the present disclosure by a person having ordinary knowledge in the art and recognized as being equivalent.

What is claimed is:

1. A system for detecting location of an electromagnetic wave source comprising a receiving array antenna, a location setting unit, a distance and angle calculation unit, and a location information calculation unit, the system being configured to detect a location of a transmitting antenna or to detect a location of an electromagnetic wave source from which an incident wave transmitted from the transmitting antenna is scattered,
wherein the distance and angle calculation unit is configured to calculate a distance rₓ from an origin point of three-dimensional coordinate axes to the transmitting antenna or the electromagnetic wave source and to calculate an angle ψₓ between an extension line from the origin point to the receiving array antenna on an x-axis and an extension line from the origin point to the transmitting antenna or the electromagnetic wave source by using [Equation 1] and [Equation 2] described below,
f(rₓ,ψₓ)=A(rₓ+(rₓ−A))=2x′rₓ cos ψᵣ_{ₓ}−x′² [Equation 1]
f(rₓ,ψₓ)=B(rₓ+(rₓ−B))=2x″rₓ cos′(π−ψₓ)−(x″)² [Equation 2]
wherein rₓ is a distance from the origin point of the three-dimensional coordinate axes to a location P(x,y,z) of the transmitting antenna or the electromagnetic wave source, and ψₓ is an angle between the extension line from the origin point to the receiving array antenna on the x-axis and the extension line from the origin point to the transmitting antenna or the electromagnetic wave source, and
wherein, A represents a distance difference between a distance from the transmitting antenna or the electromagnetic wave source to a coordinate #O(0,0,0) of the receiving array antenna and a distance from the transmitting antenna or the electromagnetic wave source to a coordinate #x+(x′,0,0) of the receiving array antenna, and B represents a distance difference between a distance from the transmitting antenna or the electromagnetic wave source to the coordinate #O(0,0,0) of the receiving array antenna and a distance from the transmitting antenna or the electromagnetic wave source to a coordinate #x−(x″,0,0) of the receiving array antenna.

2. The system for detecting location of an electromagnetic wave source of claim 1, wherein the distance and angle calculation unit is configured to calculate a distance r_{y} from the origin point of the three-dimensional coordinate axes to the transmitting antenna or the electromagnetic wave source and to calculate an angle ψ_{y} between an extension line from the origin point to the receiving array antenna on a y-axis and an extension line from the origin point to the transmitting antenna or the electromagnetic wave source by using [Equation 3] and [Equation 4] described below,
f(r_{y},ψ_{y})=C(r_{y}+(r_{y}−C))=2y′r_{y} cos ψ_{y}−y′² [Equation 3]
f(r_{y},ψ_{y})=D(r_{y}+(r_{y}−D))=2y″r_{y} cos(π−ψ_{y})−(y″)² [Equation 4]
wherein, r_{y} is a distance from the origin point of the three-dimensional coordinate axes to the location P(x,y,z) of the transmitting antenna or the electromagnetic wave source, and ψ_{y} is an angle between the extension line from the origin point to the receiving array antenna on the y-axis and the extension line from the origin point to the transmitting antenna or the electromagnetic wave source, and
wherein, C represents a distance difference between a distance from the transmitting antenna or the electromagnetic wave source to the coordinate #O(0,0,0) of the receiving array antenna and a distance from the transmitting antenna or the electromagnetic wave source to a coordinate #y+(0,y′,0) of the receiving array antenna, and D represents a distance difference between a distance from the transmitting antenna or the electromagnetic wave source to the coordinate #O(0,0,0) of the receiving array antenna and a distance from the transmitting antenna or the electromagnetic wave source to a coordinate #y−(0,y″,0) of the receiving array antenna.

3. The system for detecting location of an electromagnetic wave source system of claim 1, wherein the distance and angle calculation unit is configured to calculate a distance r_{z} from the origin point of the three-dimensional coordinate axes to the transmitting antenna or the electromagnetic wave source and to calculate an angle ψ_{z} between an extension line from the origin point to the receiving array antenna on a z-axis and an extension line from the origin point to the transmitting antenna or the electromagnetic wave source by using [Equation 5] and [Equation 6] described below,
f(r_{z},ψ_{z})=E(r_{z}+(r_{z}−E))=2z′r_{z} cos ψ_{z}−z′² [Equation 5]
f(r_{z},ψ_{z})=F(r_{z}+(r_{z}−F))=2z″r_{z} cos(π−ψ_{z})−(z″)² [Equation 6]
wherein, r_{z} is a distance from the origin point of the three-dimensional coordinate axes to the location P(x,y,z) of the transmitting antenna or the electromagnetic wave source, and ψ_{z} is an angle between the extension line from the origin point to the receiving array antenna on the z-axis and the extension line from the origin point to the transmitting antenna or the electromagnetic wave source, and
wherein, E represents a distance difference between a distance from the transmitting antenna or the electromagnetic wave source to the coordinate #O(0,0,0) of the receiving array antenna and a distance from the transmitting antenna or the electromagnetic wave source to a coordinate #z+(0,0,z′) of the receiving array antenna, and F represents a distance difference between a distance from the transmitting antenna or the electromagnetic wave source to the coordinate #O(0,0,0) of the receiving array antenna and a distance from the transmitting antenna or the electromagnetic wave source to a coordinate #z−(0,0,z″) of the receiving array antenna.

4. The system for detecting location of an electromagnetic wave source system of claim 1, wherein the location information calculation unit is configured to calculate location information of the transmitting antenna or the electromagnetic wave source by using an intersection point where the distance rₓ from the origin point to the transmitting antenna or the electromagnetic wave source and the angle ψₓ between the extension line from the origin point to the receiving array antenna on the x-axis and the extension line from the origin point to the transmitting antenna or the electromagnetic wave source calculated in the distance and angle calculation unit on the basis of the receiving array antenna on the x-axis, a distance r_{y} from the origin point to the transmitting antenna or the electromagnetic wave source and an angle ψ_{y} between an extension line from the origin point to the receiving array antenna on a y-axis and an extension line from the origin point to the transmitting antenna or the electromagnetic wave source calculated in the distance and angle calculation unit on the basis of the receiving array antenna on the y-axis, and a distance r_{z} from the origin point to the transmitting antenna or the electromagnetic wave source and an angle ψ_{z} between an extension line from the origin point to the receiving array antenna on a z-axis and an extension line from the origin point to the transmitting antenna or the electromagnetic wave source calculated in the distance and angle calculation unit on the basis of the receiving array antenna on the z-axis intersect each other.
